(19) United States
(12) Patent Application Publication
(10) Pub. No.: US 2007/0298392 A1
(43) Pub. Date: Dec. 27, 2007

(54) Candidate transition analysis method and system

(75) Inventor: Peter James Mitchell, Woodstock, GA (US)

Correspondence Address: SCHMEISER, OLSEN & WATTS, 22 CENTURY HILL DRIVE, SUITE 302, LATHAM, NY, 12110, US

(73) Assignee: International Business Machines Corporation, Armonk, NY (US)

(21) Appl. No.: 11/451,915

(22) Filed: Jun. 13, 2006

(51) Int. Cl. G09B 19/00

(52) U.S. Cl. 434/219

(57) ABSTRACT

A candidate transition analysis method and system. The system comprises a computing apparatus comprising first data. The first data comprises a specified job title and a first list comprising a first plurality of required skills for the specified job title. Candidate data and business data is received by the computing apparatus. Candidate data comprises a job candidate and a second list comprising plurality of skills related to a job held by the candidate. A plurality of scores for the candidate are calculated based on the first data, the candidate data, and the business data.

### TECHNICAL FIELD

The present invention relates to a system and associated method for performing a transition analysis for a candidate within an enterprise.

### BACKGROUND OF THE INVENTION

Reassigning an individual to perform a function typically requires a series of steps that may be complicated and inaccurate. Therefore there exists a need for a simple accurate means for reassigning an individual to perform a function.

### SUMMARY OF THE INVENTION

The present invention provides a method, comprising:

providing a computing apparatus comprising a memory device, said memory device comprising a transition analysis tool and job related data, said job related data comprising a first specified job title and a first list comprising a first plurality of required skills for said first specified job title;

receiving by said computing apparatus, job candidate data, said job candidate data comprising a job candidate and a second list comprising a first set of required skills related to a job held by said job candidate;

receiving, by said computing apparatus, job market data;

storing within said memory device, said job candidate data and said job market data;

comparing by said transition analysis tool, said first plurality of required skills with said first set of required skills to determine a first group of common skills between said first plurality of required skills and said first set of required skills;

calculating, by said transition analysis tool, a first score for said candidate by dividing the number of said first group of common skills by the number of said first plurality of required skills;

comparing by said transition analysis tool, said job market data with said first plurality of required skills to determine a first set of market valued skills from said first plurality of required skills;

calculating by said transition analysis tool, a second score for said job candidate by dividing the number of said first set of market valued skills by the number of said first plurality of required skills;

receiving, by said computing apparatus, a third list comprising a second set of required skills related to said job held by said job candidate;

receiving, by said computing apparatus, business data;

storing within said memory device, said third list and said business data;

comparing by said transition analysis tool, said first set of required skills with said second set of required skills to determine a second group of common skills between said first set of required skills and said second set of required skills;

calculating, by said transition analysis tool, a third score for said candidate by dividing the number of said second group of common skills by the number of said first set of required skills;

comparing by said career analysis tool, said business data with said first plurality of required skills to determine a first set of business valued skills from said first plurality of required skills; and

calculating by said transition analysis tool, a fourth score for said job candidate by dividing the number of said first set of business valued skills by the number of said first plurality of required skills.

The present invention provides a computing system comprising a processor coupled to a computer-readable memory unit, said memory unit comprising an transition analysis tool and job related data, said job related data comprising a first specified job title and a first list comprising a first plurality of required skills for said first specified job title, said transition analysis tool comprising instructions that when executed by the processor implement an analysis method, said method comprising:

receiving by said computing system, job candidate data, said job candidate data comprising a job candidate and a second list comprising a first set of required skills related to a job held by said job candidate;

receiving, by said computing system, job market data;

storing within said memory unit, said job candidate data and said job market data;

comparing by said transition analysis tool, said first plurality of required skills with said first set of required skills to determine a first group of common skills between said first plurality of required skills and said first set of required skills;

calculating, by said transition analysis tool, a first score for said candidate by dividing the number of said first group of common skills by the number of said first plurality of required skills;

comparing by said transition analysis tool, said job market data with said first plurality of required skills to determine a first set of market valued skills from said first plurality of required skills;

calculating by said transition analysis tool, a second score for said job candidate by dividing the number of said first set of market valued skills by the number of said first plurality of required skills;

receiving, by said computing system, a third list comprising a second set of required skills related to said job held by said job candidate;

receiving, by said computing apparatus, business data;

storing within said memory unit, said third list and said business data;

comparing by said transition analysis tool, said first set of required skills with said second set of required skills to determine a second group of common skills between said first set of required skills and said second set of required skills;

calculating, by said transition analysis tool, a third score for said candidate by dividing the number of said second group of common skills by the number of said first set of required skills;

comparing by said career analysis tool, said business data with said first plurality of required skills to determine a first set of business valued skills from said first plurality of required skills; and

calculating by said transition analysis tool, a fourth score for said job candidate by dividing the number of said first set of business valued skills by the number of said first plurality of required skills.

The present invention provides a computer program product, comprising a computer usable medium comprising job related data and a computer readable program code embodied therein, said job related data comprising a first specified job title and a first list comprising a first plurality of required skills for said first specified job title, said computer readable program code comprising a transition analysis tool adapted to implement an analysis method within a computing system, said method comprising:

receiving by said computing system, job candidate data, said job candidate data comprising a job candidate and a second list comprising a first set of required skills related to a job held by said job candidate;

receiving, by said computing system, job market data;

storing within said computer usable medium, said job candidate data and said job market data;

comparing by said transition analysis tool, said first plurality of required skills with said first set of required skills to determine a first group of common skills between said first plurality of required skills and said first set of required skills;

calculating, by said transition analysis tool, a first score for said candidate by dividing the number of said first group of common skills by the number of said first plurality of required skills;

comparing by said transition analysis tool, said job market data with said first plurality of required skills to determine a first set of market valued skills from said first plurality of required skills;

calculating by said transition analysis tool, a second score for said job candidate by dividing the number of said first set of market valued skills by the number of said first plurality of required skills;

receiving, by said computing system, a third list comprising a second set of required skills related to said job held by said job candidate;

receiving, by said computing apparatus, business data;

storing within said computer usable medium, said third list and said business data;

comparing by said transition analysis tool, said first set of required skills with said second set of required skills to determine a second group of common skills between said first set of required skills and said second set of required skills;

calculating, by said transition analysis tool, a third score for said candidate by dividing the number of said second group of common skills by the number of said first set of required skills;

comparing by said career analysis tool, said business data with said first plurality of required skills to determine a first set of business valued skills from said first plurality of required skills; and

calculating by said transition analysis tool, a fourth score for said job candidate by dividing the number of said first set of business valued skills by the number of said first plurality of required skills.

The present invention provides a process for integrating computing infrastructure, comprising integrating computer-readable code into a computer system, wherein the computer system comprises a computer usable medium, wherein said computer usable medium comprises job related data, wherein said job related data comprises a first specified job title and a first list comprising a first plurality of required skills for said first specified job title, and wherein the code in combination with the computer system is capable of performing a method comprising:

receiving by said computing system, job candidate data, said job candidate data comprising a job candidate and a second list comprising a first set of required skills related to a job held by said job candidate;

receiving, by said computing system, job market data;

storing within said computer usable medium, said job candidate data and said job market data;

comparing, said first plurality of required skills with said first set of required skills to determine a first group of common skills between said first plurality of required skills and said first set of required skills;

calculating, a first score for said candidate by dividing the number of said first group of common skills by the number of said first plurality of required skills;

comparing, said job market data with said first plurality of required skills to determine a first set of market valued skills from said first plurality of required skills;

calculating, a second score for said job candidate by dividing the number of said first set of market valued skills by the number of said first plurality of required skills;

receiving, by said computing system, a third list comprising a second set of required skills related to said job held by said job candidate;

receiving, by said computing apparatus, business data;

storing within said computer usable medium, said third list and said business data;

comparing, said first set of required skills with said second set of required skills to determine a second group of common skills between said first set of required skills and said second set of required skills;

calculating, a third score for said candidate by dividing the number of said second group of common skills by the number of said first set of required skills;

comparing, said business data with said first plurality of required skills to determine a first set of business valued skills from said first plurality of required skills; and

calculating, a fourth score for said job candidate by dividing the number of said first set of business valued skills by the number of said first plurality of required skills.

The present invention advantageously provides a simple accurate means for reassigning an individual to perform a function.

### BRIEF DESCRIPTION OF THE DRAWINGS

FIG. 1 illustrates a block diagram of an analysis system for determining suitable jobs for various candidates based on data related to job skills, in accordance with embodiments of the present invention.

FIG. 2 illustrates a flowchart describing an algorithm for an analysis process used by the transition analysis tool in the analysis system of FIG. 1, in accordance with embodiments of the present invention.

FIG. 3 illustrates a computer system used for determining suitable jobs for various candidates based on data related to job skills, in accordance with embodiments of the present invention

### BEST MODE FOR CARRYING OUT THE INVENTION

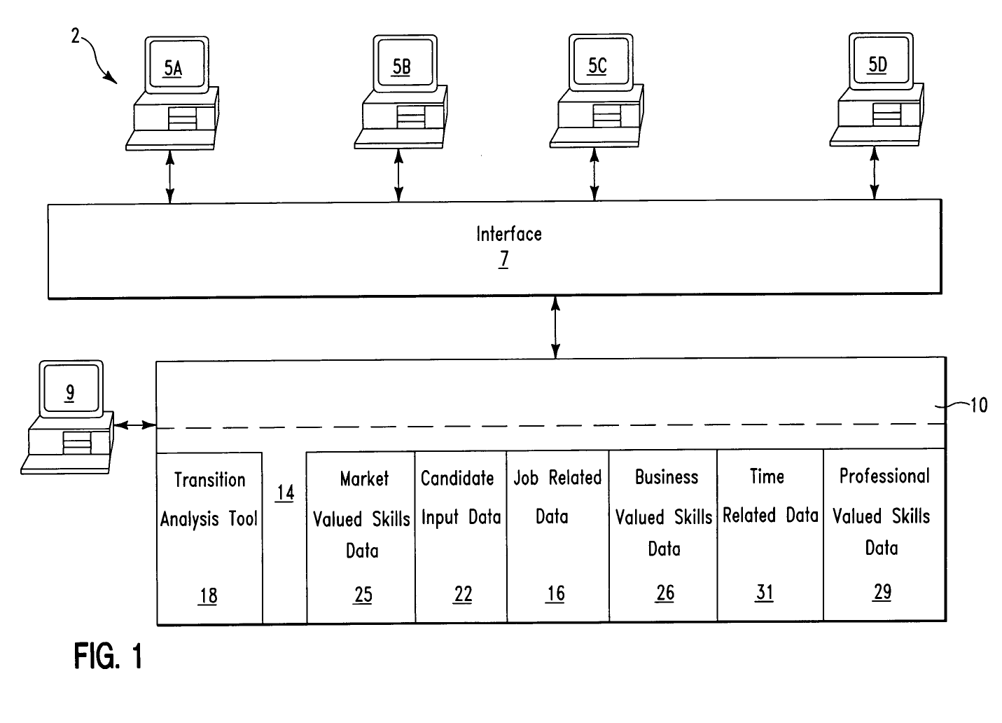

FIG. 1 illustrates a block diagram of an analysis system 2 for determining suitable jobs for various candidates based on data related to job skills, in accordance with embodiments of the present invention. System 2 comprises a plurality of input terminals 5A . . . 5D connected to a computing apparatus 10 through an interface 7. Interface 7 may comprise any type of interface known to a person of ordinary skill in the art including, inter alia, a local area network, (LAN), a wide area network (WAN), the Internet, etc. Computing apparatus 10 may comprise any type of computing apparatus including, inter alia, a personal computer (PC), a server computer, etc. Additionally, system 2 comprises an administrator computer 9 connected to computing apparatus 10. Computing apparatus 10 comprises a memory apparatus 14. Memory apparatus 14 comprises a transition analysis tool 18, job related data 16, candidate input data 22, market valued skills data 25, business valued skills data 26, professional valued skills data 29, and time related data 31 comprising time estimates for formal education and practical application related to job related data 16. Job related data 16, market valued skills data 25, business valued skills data 26, professional valued skills data 29, and time related data 31 may be inputted into computing apparatus through administrator computer 9. Candidate input data 22 may be inputted into computing apparatus 10 through any of input terminals 5A . . . 5D. Job related data 16 comprises a list of specified job titles (e.g., computer programmers, data architect, network architects, etc) and associated required skills necessary to perform each specified job title. Candidate input data 22 comprises a list of candidates (e.g., job applicants) for the specified job titles from job related data 16. Additionally, candidate input data 22 comprises lists of required job skills related to a currently held position (i.e., job) by each candidate.

Market valued skills data 25 comprises data for determining which of the associated required skills from job related data 16 comprises a market valued skill. A market valued skill is defined herein as a critical “hot” market place skill that is required to perform specified job and linked with business unit skills aligned to the achievement of business priorities (e.g., growth in revenue and innovation). A market valued skill comprises a job related skill that when applied to a job will produce significant revenue, drive significant innovation, and is aligned with a market direction and particular business strategy for an entity or business. Market valued skills are dynamic and change as new products and services are introduced into the market place (e.g., as technology changes at a rapid pace market valued skills also change at a rapid pace). Therefore, “hot” job related skills may become “cold” in a short period of time (e.g., a few months). Transition analysis tool 18 in system 2 allows for a periodic (e.g., bi-annually) review and update of the market valued skills from market valued skills data 25. Therefore entities may stay on top of which job related skills are in demand (i.e., comprise market valued skills). External and internal market related data may be used to determine and update which job related skills comprise market valued skills. External market related data which identifies market valued skills may comprise any market related data known to a person of ordinary skill in the art including, inter alia, the Foote report, the Gartner group report, internet market data sources, etc. As a first example, the Foote report publishes a series of research products that comprises quarterly reports on “hot” trends/skills in the marketplace. The quarterly reports are developed via a continuous monitoring of compensation, attitudes, and workplace experiences of IT (Internet technology) workers in the U.S., Canada, UK and Europe. As a second example, the Gartner group report comprises research and analysis about the global information technology industry. Internal market related data may comprise any market related data known to a person of ordinary skill in the art including, inter alia, resource and capacity planning data for an entity, workforce management data for an entity such as attrition and demand growth in specific environment areas (products/services/offerings), etc. Transition analysis tool 18 comprises software.

Business valued skills data 26 comprises data for determining which associated required skills from the job related data 16 comprises a business valued skill. Business valued skills are defined herein as skills that are required to keep an entity (e.g., a company or business) highly competitive. Business valued skills must be developed or maintained. A business valued skill comprises a job related skill that when applied to a job will keep the entity functioning. Business valued skills comprise skills that an entity requires. These skills are not market focused or driven. Business valued skills may be dynamic and change as new products and services are introduced within the entity. Therefore, some business valued skills could become market valued skills and some market valued skills could eventually become business valued skills. Transition analysis tool 18 within system 2 allows for a periodic (e.g., bi-annually) review and update of the business valued skills from the business valued skills data 26. Therefore entities may stay on top of which job related skills are needed. External and internal data may be used to determine and update which job related skills comprise business valued skills. The external and internal data may comprise data retrieved from business line/unit input, geographical input, strategic business planning input, workforce management initiative input, etc. For examples business valued skills may comprise, inter alia, key business process skills, manufacturing skills, research and development type skills, etc.

Professional valued skills data 29 comprises professional valued skills that comprise job related skills that when applied to a job will keep the entity functioning and must be maintained. These are skills that are necessary to be an effective employee (i.e., for an entity or enterprise) and perform successfully in a given job role. Professional valued skills are the least dynamic of all of the aforementioned skills but may change over time as new products and services are introduced within the entity. Criteria for professional valued skills may comprise skills that support foundational or leadership competencies, profession or “Core” Skills for job roles, skills required for legal compliance, etc. Examples of professional valued skills may comprise communication or negotiation type skills required for legal or compliance reasons, negotiation skills, health/safety Skills, etc. Therefore, some professional valued skills could become business valued skills. Transition analysis tool 18 in system 2 allows for a periodic (e.g., bi-annually) review and update of the professional valued skills from professional valued skills data 29. Therefore entities may stay on top of which job related skills are needed. External and internal market related data may be used to determine and update which job related skills comprise professional valued skills. Internal company related data may comprise any related data known to a person of ordinary skill in the art including, inter alia, resource and capacity planning data for an entity, workforce management data for an entity such as attrition and demand growth in specific environment areas (products/services/offerings), etc.

Transition analysis tool 18 in system 2 of FIG. 1 allows job related data 16 to be compared to candidate input data 22 and a weighting factor(s) may be applied to the comparison to analyze a candidate's qualifications for specified job titles applied for by the candidate. Additionally, transition analysis tool 18 in system 2 may be used to determine alternative job titles for the candidate other than those applied for by the candidate. The following example for implementation of transition analysis tool 18 in system 2 to determine a candidate's qualifications for job titles is described with reference to Tables 1-3, infra. The implementation example illustrates a candidate attempting to move from a first job title (Data Architect) to a second job title (Network Architect).

Table 1 illustrates job related skills associated with a Data Architect job title currently held by the candidate (i.e., an example of candidate input data 22).

TABLE 1

| Job Title | Possessed Job related Skills |
|---|---|
| Data Architect | Advise on database |
| | Performance/Tuning/Measurement |
| | Apply data modeling techniques to IT |
| | solutions |
| | Communication |
| | Advise for business intelligence strategy |
| | Architect for IT solutions using databases |
| | Design data warehouse & data market |
| | Structure |
| | Design physical data model |

The first column comprises a Data Architect job title. The second column comprises a list of job related skills associated with a Data Architect job title currently held by the candidate.

Table 2 illustrates job related skills required to obtain a Network Architect job title (i.e., an example of job related data 16).

TABLE 2

| Job Title | Required Job related Skills |
|---|---|
| Network Architect | Communication |
| | Design solutions using LAN technology |
| | Design solutions using network support |
| | services |
| | Design solutions using WAN technology |
| | Develop network architecture |
| | Develop networking requirements |
| | Perform logical topology selection |

The first column comprises a Network Architect job title. The second column comprises a list of job related skills required to obtain a Network Architect job title. Note that column 2, rows 2-7 (emphasis added) each comprise a required job skill for the Network architect title that is not associated with the current job (i.e., Data Architect) possessed by the candidate represented in Table 1.

Table 3 illustrates job related skills required to obtain a Network Architect job title as compared to job related skills associated with a Data Architect job title currently held by the candidate (i.e., common skills between Network Architect job title and Data Architect job title) applying for the Network Architect job title and currently holding a Data Architect job title. Additionally, Table 3 illustrates which of the job related skills required to obtain a Network Architect job title comprise market valued skills, business valued skills, and professional valued skills. This comparison between skills and determination of market valued skills, business valued skills, and professional valued skills are performed by transition analysis tool 18.

TABLE 3

| | | Matching/ | | | |
|---|---|---|---|---|---|
| | Required Job related | Common | Business | Professional | Market |
| Job Title | Skills | Skills | Valued | Valued | valued skills |
| Network | Communication | Yes | No | Yes | No |
| Architect | | | | | |
| | Design Solutions Using | No | No | No | Yes |
| | LAN Technology | | | | |
| | Design Solutions Using | No | No | No | Yes |
| | Network Support Services | | | | |
| | Design Solutions Using | No | No | No | Yes |
| | WAN Technology | | | | |
| | Develop Network | No | No | No | Yes |
| | Architecture | | | | |
| | Develop Networking | No | Yes | No | No |
| | Requirements | | | | |
| | Perform Logical Topology | No | No | No | Yes |
| | Selection | | | | |

The first column comprises a Network Architect job title. The second column comprises a list of job related skills required to obtain a Network Architect job title. The third column comprises common skills (i.e., represented by a Yes) between Network Architect job title (i.e., required skills) and Data Architect job title (i.e., current job title held by candidate). This example comprises 1 common skill. The fourth column comprises required skills to obtain a Network Architect job title that comprise business valued skills (i.e., represented by a Yes). The fifth column comprises required skills to obtain a Network Architect job title that comprise professional valued skills (i.e., represented by a Yes). The sixth column comprises required skills to obtain a Network Architect job title that comprise market valued skills (i.e., represented by a Yes). Each of the required skills may be analyzed individually by transition analysis tool 18 to determine whether or not they comprise a market valued skill, business valued skill, or professional valued skill. Market valued skills are determined using external and internal market related data to determine and update which job related skills comprise market valued skills as described, supra. External market related data which identifies market valued skills may comprise any market related data known to a person of ordinary skill in the art including, inter alia, the Foote report, the Gartner group report, internet market data sources, etc as described, supra. A business valued skill is defined as skills that are required to keep the entity highly competitive and must be developed or maintained. Professional valued skills are necessary to be an effective employee and perform successfully in a given job role.

Based on a number of market valued skills, business valued skills, and professional valued skills determined (6 in this example), a weighting factor (i.e., based on a number of market valued skills, business valued skills, and professional valued skills divided by a total number of required skills) may be assigned to the job skills comparison. Therefore, transition analysis tool 18 determines common skills between the two job titles (i.e., Data Architect job title and Network Architect job title) and which required job skills for the Network Architect job title that the entity or business should be considered in demand skills in the market place (i.e., market valued skills, business valued skills, professional valued skills, etc.). Transition analysis tool 18 may calculate an analysis score(s) to determine if a candidate is a good match for a job (e.g., if the candidate holding the Data Architect job title is a good candidate for the Network Architect job title). A first analysis score (e.g., for a market valued skills calculation) is based on a first weighting factor assigned to the job skills comparison (i.e., common skills) using the following Equation 1.

Analysis score=Common skills*1/Total required skills+Weighting factor (Equation 1)

The weighting factor is calculated by dividing a number of market valued skills, business valued skills, and professional valued skills by a total number of required skills. Therefore, based on data from Tables 1-3, transition analysis tool 18 determines a market valued skill factor:
Common skills=1
Total required skills=7 and therefore 1/Total required skills= 1/7 or 0.14
Weighting factor=Market valued skills/Total required skills= 5/7 or 0.71.

Therefore, using Equation 1, an analysis score may be calculated (i.e., by transition analysis tool 18) as follows:

Analysis score=Common skills*1/Total required skills+Weighting factor

Analysis score=7* 1/7+ 5/7

Analysis score=0.85

Equation 1 will calculate analysis scores comprising a range of 0 to 2 with 0 indicating that the candidate is not a match for a specific job and 2 indicating that the candidate is a perfect match for a specific job. The analysis score is compared to a predetermined value to determine an action performed for the candidate (e.g., recommend that the candidate is a match for a specific job, reject a candidate for a specific job, recommend a training program to prepare the candidate for a specific job). For example, any analysis score comprising a range of greater than or equal to 1 (i.e., 1 is the predetermined value) is considered to be a good match for a specific job because the candidate is determined to possess an adequate number of required skills and therefore any training time required to move from a current job position to a desired job position would be minimal. Any analysis score comprising a range of less than or equal to 1 (i.e., 1 is the predetermined value) is not considered to be a good match for a specific job because the candidate is not determined to possess an adequate number of required skills. However, if there is no time limitation related to training time then candidates comprising an analysis score of less than 1 may be considered. Therefore, based of the implementation example with respect to Tables 1-3, the candidate was determined to have a first analysis score of 0.85 (i.e., less than or equal to 1) and therefore the candidate is not considered to be a good match for the Network Architect job.

A second analysis score (e.g., for a business valued skills calculation) is based on A second weighting factor assigned to the job skills comparison (i.e., common skills) using Equation 1.

Analysis score=Common skills*1/Total required skills+Weighting factor (Equation 1)

The weighting factor is calculated by dividing a number of market valued skills, business valued skills, and professional valued skills by a total number of required skills. Therefore, based on data from Tables 1-3, transition analysis tool 18 determines a business valued skill factor:
Common skills=1
Total required skills=7 and therefore 1/Total required skills= 1/7 or 0.14
Weighting factor=business valued skills/Total required skills= 1/7 or 0.14.
   Therefore, using Equation 2, an analysis score may be calculated (i.e., by transition analysis tool 18) as follows:

Analysis score=Common skills*1/Total required skills+Weighting factor

Analysis score=7* 1/7+ 1/7

Analysis score=0.28

Therefore, based of the implementation example with respect to Tables 1-3, the candidate was determined to have a second analysis score of 0.28 (i.e., less than or equal to 1) and therefore the candidate is not considered to be a good match for the Network Architect job.

A third analysis score (e.g., for a—professional valued skills calculation) is based on a third weighting factor assigned to the job skills comparison (i.e., common skills) using Equation 1.

Analysis score=Common skills*1/Total required skills+Weighting factor (Equation 1)

The weighting factor is calculated by dividing a number of market valued skills, business valued skills, and professional valued skills by a total number of required skills. Therefore, based on data from Tables 1-3, transition analysis tool 18 determines that professional valued skill factor:
Common skills=1
Total required skills=7 and therefore 1/Total required skills= 1/7 or 0.14
Weighting factor=professional valued skills/Total required skills= 1/7 or 0.14.
   Therefore, using Equation 3, an analysis score may be calculated (i.e., by transition analysis tool 18) as follows:

Analysis score=Common skills*1/Total required skills+Weighting factor

Analysis score=7* 1/7+ 1/7

Analysis score=0.28

Therefore, based of the implementation example with respect to Tables 1-3, the candidate was determined to have an analysis score of 0.28 (i.e., less than or equal to 1) and therefore the candidate is not considered to be a good match for the Network Architect job.

Additionally, prior to calculating the analysis scores, a first fraction of common skills scores between the two job titles (i.e., Common skills*1/Total required skills from Equation 1) may be compared to a first predetermined value and a second fraction of market valued skills, business valued skills, or professional valued skills with respect to a total number of required skills for the requested job title (i.e., using first, second, and third weighting factors) may be compared to a second predetermined value. In this instance, the first predetermined value would have to be equal to or exceeded by the first fraction and the second predetermined value would have to be equal to or exceeded by the second fraction in order to calculate an analysis score. If the first predetermined value is not equal to or exceeded by the first fraction and/or the second predetermined value is not equal to or exceeded by the second fraction, then an analysis score is not calculated due to a possibility of calculating an inaccurate analysis score. For example, if not enough common skills exist but a large number of market valued skills, business valued skills, or professional valued skills exist, the candidate may obtain an acceptable analysis score without possessing enough common skills. Therefore, the first predetermined value is not exceeded by the first fraction but the second predetermined value is not exceeded by the second fraction so, it is not necessary to calculate the analysis score because not enough common skills exist to provide an accurate analysis score. Additionally, each of the market valued skills, business valued skills, or professional valued skills and each of the common skills may be weighted (i.e., a weighting factor applied) before an analysis score is calculated. As a first example, each of the common skills may be weighted according to a relative importance (e.g., by an expert in the field) to the requested job (e.g., for a Network Architect it may be determined that an Apply IT standards skill is more important that a communications skill and therefore the Apply IT standards skill is weighted higher). As a second example, each of the market valued skills, business valued skills, or professional valued skills may be weighted according to an amount of time that the market valued skill, business valued skills, or professional valued skills have been determined to be a market valued skill, business valued skills, or professional valued skills (e.g., the greater the amount of time that the market valued skill, business valued skills, or professional valued skills has been determined to be a market valued skill, business valued skills, or professional valued skills, the higher the weighting).

Transition analysis tool 18 may be used for (and the implementation example with respect to Tables 1-3 may be applied to) calculating several analysis scores for a candidate for several job titles and specific job titles may be recommended by transition analysis tool 18 based on a comparison of each the analysis scores to each other. Additionally, transition analysis tool 18 may determine a skills delta between job related skills associated with a job held by the candidate and required skills necessary to obtain a desired position (i.e., required skills missing from the candidate's current job). Transition analysis tool 18 may determine a training program for the candidate for obtaining the missing required skills determined by the skills delta. For example, with respect to the implementation example with respect to Tables 1-3, the candidate would be determined to have a skills delta of 6 (i.e., 6 missing required skills as indicated by “No” in Column 3 of Table 3). Transition analysis tool 18 may develop a training program for the candidate so that the candidate could acquire the 6 missing required skills.

Additionally, time related data 31 comprising formal education time estimates and practical application time estimates for each individual skill mapped back to the specified job title may be applied to the analysis scores. This data comprises time estimates for acquiring specific skills information through formal learning programs and through practical application of the skills via on the job experience, mentoring, or other type of hands-on experience. The time related data 31 is segmented into specific blocks of time. The time related data 31 for each transition area is then calculated based on a specific weighting which takes into account first specified job title skills as illustrated by equation 2 (i.e., estimation of formal learning times).

Formal learning time est.=Sum of missing skills factors*0.12 (0.01 for each month in a year) (Equation 2)

The transition analysis tool 18 additionally estimates times for learning and practical application. An estimate for moving from one job role to another job role takes into consideration both formal education and practical application (practical experience such as on the job training and mentoring activities). These activities allow an individual to apply and master the skills and close the specific skill gaps identified by the transition analysis tool 18.

For example, each job role skill set and related profession or core skills are linked to a weight factor which estimates the duration:

| Duration | | Weight Factor |
|---|---|---|
| 0 | days | 0 |
| 1 to 14 | days | 1 |
| 15 to 30 | days | 2 |
| 31 to 60 | days | 3 |
| 61 to 90 | days | 4 |
| 91 to 180 | days | 5 |
| 181 to 360 | days | 6 |
| 360+ | days | 7 |

From a sum of the weight factors, a calculation (an average time for formal education and practical application) is provided. Education duration is provided in terms of time spent on formal learning, but not in elapsed time, taking into account the duration between two education activities.

From the Network Architect job role example as described, supra, there are 7 required total skills. In the transition analysis tool 18 each skill has been assigned an estimate factor. This factor correlates to the above table. Each of the 7 required skills for the Network Architect job role has been assigned a 1 (1 to 14 days of formal education needed for each skill). A sum of missing skills factors is described as (1,1,1,1,1,1)=6 and 6*0.12=0.72 months of formal education. Therefore, it will take 0.72 months of total formal education for this individual to acquire the skills that are missing when transitioning from a Data Architect to a Network Architect.

From the Network Architect job role example as described, supra a practical application time estimate is calculated using equation 3 as follows:

Practical Application time estimate=Sum of missing skills factors*0.18 (0.01 for each month in a year plus an additional 0.06 or half year due to this type of application takes longer than formal learning) (Equation 3)

From the Network Architect job role example, there are 7 required total skills. In the transition analysis tool each skill has been assigned an estimate factor. This factor correlates to the above figure. Each of the 7 required skills for the Network Architect job role have been assigned factors of: 2, 4, 3, 4, 5, 5, 5. The factors of the six skills that are missing are 4, 3, 4, 5, 5, 5

### Sum of missing skills factors (4+3+4+5+5+5)=26

26*0.18=4.68 months of practical application education. Therefore it is determined that it will take 4.68 months of total practical application experience for this individual to acquire the skills that are missing when transitioning from a Data Architect to a Network Architect.

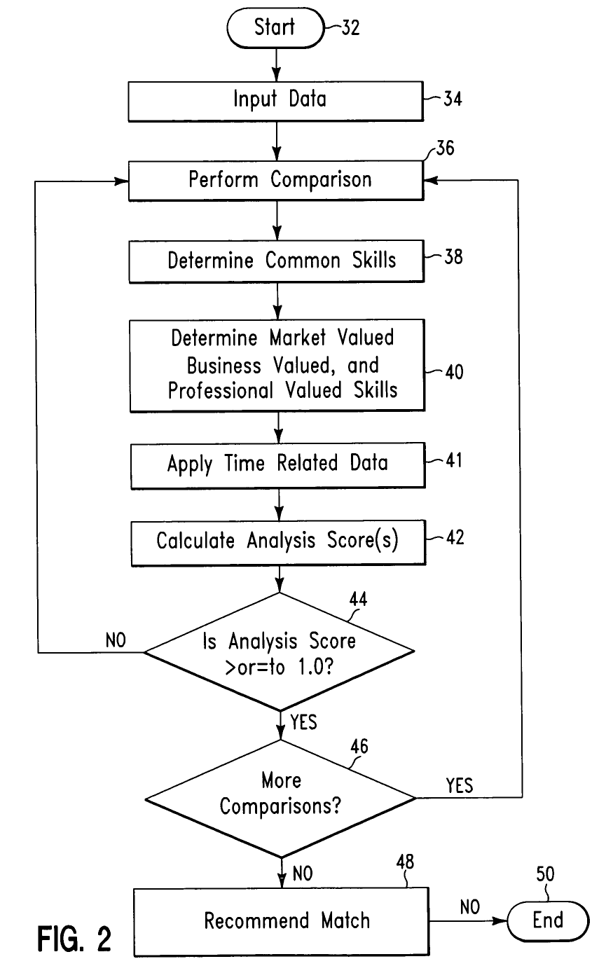

FIG. 2 illustrates a flowchart describing an algorithm for an analysis process used by transition analysis tool 18 in system 2 of FIG. 1, in accordance with embodiments of the present invention. In step 32, the process is initiated. In step 34, job related data 16, candidate input data 22, market valued skills data 25, business valued skills data 26, time related data 31, and professional valued skills data 29 are inputted into system 2. In step 36, a comparison is performed between required skills for a job title held by a candidate and required skills necessary for a desired job title (i.e., position). In step 38, common skills are determined between required skills for a job title held by a candidate and required skills necessary for a desired job title. Additionally, as described supra in the description of FIG. 1, the common skills may be weighted or compared to a predetermined value. In step 40, market valued skills, business valued skills, and professional valued skills are determined for the required skills based on market valued skills data 25, business valued skills data 26, and professional valued skills data 29. Additionally, as described supra in the description of FIG. 1, the market valued skills, business valued skills, and professional valued skills may be weighted or compared to a predetermined value. In step 41, time related data 31 is applied to the common skills determined in step 38. In step 42, an analysis score(s) is calculated using Equation 1 (see description of FIG. 1, supra). In step 44, it is determined if the analysis score is greater than or equal to 1.0. If in step 44 it is determined that the analysis score(s) is not greater than or equal to 1.0 (i.e., less than 1.0), then step 36 is repeated to perform another comparison between job related skills for a job title held by a candidate and required skills necessary for another desired job title. If in step 44 it is determined that the analysis score is greater than or equal to 1.0, then in step 46 it is determined if more comparisons are necessary to determine additional job matches for the candidate. If in step 46 it is determined that more comparisons are necessary to determine additional job matches for the candidate, then step 36 is repeated to determine additional job matches for the candidate. If in step 46 it is determined that more comparisons are not necessary to determine additional job matches for the candidate, then in step 48 a job title is recommenced for the candidate and the process is terminated in step 50.

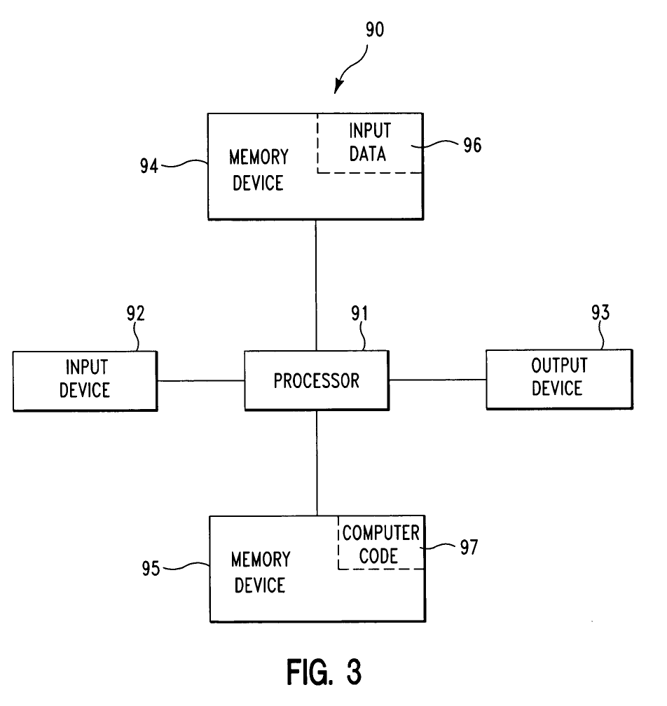

FIG. 3 illustrates a computer system 90 used for determining suitable jobs for various candidates based on data related to job skills, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen (e.g., a monitor), a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes an algorithm for determining suitable jobs for various candidates based on data related to job skills. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 3) may comprise the algorithm of FIG. 2 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Thus the present invention discloses a process for deploying or integrating computing infrastructure, comprising integrating computer-readable code into the computer system 90, wherein the code in combination with the computer system 90 is capable of performing a method for determining suitable jobs for various candidates based on data related to job skills.

While FIG. 3 shows the computer system 90 as a particular configuration of hardware and software, any configuration of hardware and software, as would be known to a person of ordinary skill in the art, may be utilized for the purposes stated supra in conjunction with the particular computer system 90 of FIG. 3. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method, comprising:
providing a computing apparatus comprising a memory device, said memory device comprising a transition analysis tool and job related data, said job related data comprising a first specified job title and a first list comprising a first plurality of required skills for said first specified job title;
receiving by said computing apparatus, job candidate data, said job candidate data comprising a job candidate and a second list comprising a first set of required skills related to a job held by said job candidate;
receiving, by said computing apparatus, job market data;
storing within said memory device, said job candidate data and said job market data;
comparing by said transition analysis tool, said first plurality of required skills with said first set of required skills to determine a first group of common skills between said first plurality of required skills and said first set of required skills;
calculating, by said transition analysis tool, a first score for said candidate by dividing the number of said first group of common skills by the number of said first plurality of required skills;
comparing by said transition analysis tool, said job market data with said first plurality of required skills to determine a first set of market valued skills from said first plurality of required skills;
calculating by said transition analysis tool, a second score for said job candidate by dividing the number of said first set of market valued skills by the number of said first plurality of required skills;
receiving, by said computing apparatus, a third list comprising a second set of required skills related to said job held by said job candidate;
receiving, by said computing apparatus, business data;
storing within said memory device, said third list and said business data;
comparing by said transition analysis tool, said first set of required skills with said second set of required skills to determine a second group of common skills between said first set of required skills and said second set of required skills;
calculating, by said transition analysis tool, a third score for said candidate by dividing the number of said second group of common skills by the number of said first set of required skills;
comparing by said career analysis tool, said business data with said first plurality of required skills to determine a first set of business valued skills from said first plurality of required skills; and
calculating by said transition analysis tool, a fourth score for said job candidate by dividing the number of said first set of business valued skills by the number of said first plurality of required skills.

2. The method of claim 1, further comprising:
receiving, by said computing apparatus, a fourth list comprising a third set of required skills related to said job held by said job candidate;
receiving, by said computing apparatus, professional/personal data;
storing within said memory device, said fourth list and said professional/personal data;
comparing by said transition analysis tool, said first set of required skills with said third set of required skills to determine a second group of common skills between said first set of required skills and said third set of required skills;
calculating, by said transition analysis tool, a fourth score for said candidate by dividing the number of said second group of common skills by the number of said first set of required skills;
comparing by said career analysis tool, said professional/personal data with said first set of required skills to determine a first set of professional/personal valued skills from said first set of required skills; and
calculating by said transition analysis tool, a fifth score for said job candidate by dividing the number of said first set of professional/personal valued skills by the number of said first set of required skills.

3. The method of claim 2, further comprising:
receiving, by said computing apparatus, time related data comprising formal education time estimates and practical application time estimates for learning said first specified job title; and
applying said time related data to said first score, said second score, said third score, said fourth score, and said fifth score.

4. The method of claim 2, further comprising:
calculating by said transition analysis tool, a first analysis score for said job candidate in relation to said first specified job title, wherein said first analysis score is based on a function of said first score, said second score, said third score, said fourth score, and said fifth score;
comparing said first analysis score to a first predetermined value; and
performing an action for said job candidate based on said comparing.

5. The method of claim 4, further comprising:
determining that said comparing said first analysis score to a first predetermined value results in said first analysis score exceeding said first predetermined value, wherein said performing said action comprises recommending said first specified job title to said job candidate.

6. The method of claim 4, further comprising:
determining that said comparing said first analysis score to a first predetermined value results in said first analysis score being less than said first predetermined value, wherein said performing said action comprises rejecting said first specified job title for said job candidate.

7. The method of claim 2, further comprising:
comparing by said transition analysis tool, said first score to a first predetermined value;
determining that said comparing said first score to said first predetermined value results in said first score exceeding said first predetermined value;
comparing by said transition analysis tool, said second score to a second predetermined value;
determining that said comparing said second score to said second predetermined value results in said second score exceeding said second predetermined value;
comparing by said transition analysis tool, said third score to a third predetermined value;
determining that said comparing said third score to said third predetermined value results in said third score exceeding said third predetermined value;
comparing by said transition analysis tool, said fourth score to a fourth predetermined value;
determining that said comparing said fourth score to said fourth predetermined value results in said fourth score exceeding said fourth predetermined value;
comparing by said transition analysis tool, said fifth score to a fifth predetermined value;
determining that said comparing said fifth score to said fifth predetermined value results in said fifth score exceeding said fifth predetermined value;
calculating by said transition analysis tool, a first analysis score for said job candidate in relation to said first specified job title, wherein said first analysis score is based on a function of said first score, said second score, said third score, said fourth score, and said fifth score;
comparing said first analysis score to a sixth predetermined value; and
performing an action for said job candidate based on said comparing said first analysis score to said sixth predetermined value.

8. The method of claim 7, further comprising:
determining that said comparing said first analysis score to said sixth predetermined value results in said first analysis score exceeding said sixth predetermined value, wherein said performing said action comprises recommending said first specified job title to said job candidate

9. The method of claim 7, further comprising:
determining that said comparing said first analysis score to said sixth predetermined value results in said first analysis score being less than said sixth predetermined value, wherein said performing said action comprises rejecting said first specified job title for said job candidate.

10. The method of claim 1, further comprising:
removing by said transition analysis tool, said first group and said second group of common skills from said first plurality of required skills to determine a first set of missing skills; and
recommending by said transition analysis tool, a training program for said job candidate to acquire said first set of missing skills.

11. A computing system comprising a processor coupled to a computer-readable memory unit, said memory unit comprising an transition analysis tool and job related data, said job related data comprising a first specified job title and a first list comprising a first plurality of required skills for said first specified job title, said transition analysis tool comprising instructions that when executed by the processor implement an analysis method, said method comprising:
receiving by said computing system, job candidate data, said job candidate data comprising a job candidate and a second list comprising a first set of required skills related to a job held by said job candidate;
receiving, by said computing system, job market data;
storing within said memory unit, said job candidate data and said job market data;
comparing by said transition analysis tool, said first plurality of required skills with said first set of required skills to determine a first group of common skills between said first plurality of required skills and said first set of required skills;
calculating, by said transition analysis tool, a first score for said candidate by dividing the number of said first group of common skills by the number of said first plurality of required skills;
comparing by said transition analysis tool, said job market data with said first plurality of required skills to determine a first set of market valued skills from said first plurality of required skills;
calculating by said transition analysis tool, a second score for said job candidate by dividing the number of said first set of market valued skills by the number of said first plurality of required skills;
receiving, by said computing system, a third list comprising a second set of required skills related to said job held by said job candidate;
receiving, by said computing apparatus, business data;
storing within said memory unit, said third list and said business data;
comparing by said transition analysis tool, said first set of required skills with said second set of required skills to determine a second group of common skills between said first set of required skills and said second set of required skills;
calculating, by said transition analysis tool, a third score for said candidate by dividing the number of said second group of common skills by the number of said first set of required skills;
comparing by said career analysis tool, said business data with said first plurality of required skills to determine a first set of business valued skills from said first plurality of required skills; and
calculating by said transition analysis tool, a fourth score for said job candidate by dividing the number of said first set of business valued skills by the number of said first plurality of required skills.

12. The computing system of claim 11, wherein said method further comprises:
receiving, by said computing system, a fourth list comprising a third set of required skills related to said job held by said job candidate;
receiving, by said computing system, professional/personal data;
storing within said memory unit, said fourth list and said professional/personal data;
comparing by said transition analysis tool, said first set of required skills with said third set of required skills to determine a second group of common skills between said first set of required skills and said third set of required skills;
calculating, by said transition analysis tool, a fourth score for said candidate by dividing the number of said second group of common skills by the number of said first set of required skills;
comparing by said career analysis tool, said professional/personal data with said first set of required skills to determine a first set of professional/personal valued skills from said first set of required skills; and
calculating by said transition analysis tool, a fifth score for said job candidate by dividing the number of said first set of professional/personal valued skills by the number of said first set of required skills.

13. The computing system of claim 12, wherein said method further comprises:
receiving, by said computing system, time related data comprising formal education time estimates and practical application time estimates for learning said first specified job title; and
applying said time related data to said first score, said second score, said third score, said fourth score, and said fifth score.

14. The computing system of claim 12, wherein said method further comprises:
calculating by said transition analysis tool, a first analysis score for said job candidate in relation to said first specified job title, wherein said first analysis score is based on a function of said first score, said second score, said third score, said fourth score, and said fifth score;
comparing said first analysis score to a first predetermined value; and
performing an action for said job candidate based on said comparing.

15. The computing system of claim 14, wherein said method further comprises:
determining that said comparing said first analysis score to a first predetermined value results in said first analysis score exceeding said first predetermined value, wherein said performing said action comprises recommending said first specified job title to said job candidate.

16. The computing system of claim 14, wherein said method further comprises:
determining that said comparing said first analysis score to a first predetermined value results in said first analysis score being less than said first predetermined value, wherein said performing said action comprises rejecting said first specified job title for said job candidate.

17. The computing system of claim 12, wherein said method further comprises:
comparing by said transition analysis tool, said first score to a first predetermined value;
determining that said comparing said first score to said first predetermined value results in said first score exceeding said first predetermined value;
comparing by said transition analysis tool, said second score to a second predetermined value;
determining that said comparing said second score to said second predetermined value results in said second score exceeding said second predetermined value;
comparing by said transition analysis tool, said third score to a third predetermined value;
determining that said comparing said third score to said third predetermined value results in said third score exceeding said third predetermined value;
comparing by said transition analysis tool, said fourth score to a fourth predetermined value;
determining that said comparing said fourth score to said fourth predetermined value results in said fourth score exceeding said fourth predetermined value;
comparing by said transition analysis tool, said fifth score to a fifth predetermined value;
determining that said comparing said fifth score to said fifth predetermined value results in said fifth score exceeding said fifth predetermined value;
calculating by said transition analysis tool, a first analysis score for said job candidate in relation to said first specified job title, wherein said first analysis score is based on a function of said first score, said second score, said third score, said fourth score, and said fifth score;
comparing said first analysis score to a sixth predetermined value; and
performing an action for said job candidate based on said comparing said first analysis score to said sixth predetermined value.

18. The computing system of claim 17, wherein said method further comprises:
determining that said comparing said first analysis score to said sixth predetermined value results in said first analysis score exceeding said sixth predetermined value, wherein said performing said action comprises recommending said first specified job title to said job candidate

19. The computing system of claim 17, wherein said method further comprises:
determining that said comparing said first analysis score to said sixth predetermined value results in said first analysis score being less than said sixth predetermined value, wherein said performing said action comprises rejecting said first specified job title for said job candidate.

20. The computing system of claim 11, wherein said method further comprises:
removing by said transition analysis tool, said first group and said second group of common skills from said first plurality of required skills to determine a first set of missing skills; and
recommending by said transition analysis tool, a training program for said job candidate to acquire said first set of missing skills.

21. A computer program product, comprising a computer usable medium comprising job related data and a computer readable program code embodied therein, said job related data comprising a first specified job title and a first list comprising a first plurality of required skills for said first specified job title, said computer readable program code comprising a transition analysis tool adapted to implement an analysis method within a computing system, said method comprising:
receiving by said computing system, job candidate data, said job candidate data comprising a job candidate and a second list comprising a first set of required skills related to a job held by said job candidate;
receiving, by said computing system, job market data;
storing within said computer usable medium, said job candidate data and said job market data;
comparing by said transition analysis tool, said first plurality of required skills with said first set of required skills to determine a first group of common skills between said first plurality of required skills and said first set of required skills;
calculating, by said transition analysis tool, a first score for said candidate by dividing the number of said first group of common skills by the number of said first plurality of required skills;
comparing by said transition analysis tool, said job market data with said first plurality of required skills to determine a first set of market valued skills from said first plurality of required skills;
calculating by said transition analysis tool, a second score for said job candidate by dividing the number of said first set of market valued skills by the number of said first plurality of required skills;
receiving, by said computing system, a third list comprising a second set of required skills related to said job held by said job candidate;
receiving, by said computing apparatus, business data;
storing within said computer usable medium, said third list and said business data;
comparing by said transition analysis tool, said first set of required skills with said second set of required skills to determine a second group of common skills between said first set of required skills and said second set of required skills;
calculating, by said transition analysis tool, a third score for said candidate by dividing the number of said second group of common skills by the number of said first set of required skills;
comparing by said career analysis tool, said business data with said first plurality of required skills to determine a first set of business valued skills from said first plurality of required skills; and
calculating by said transition analysis tool, a fourth score for said job candidate by dividing the number of said first set of business valued skills by the number of said first plurality of required skills.

22. The computer program product of claim 21, wherein said method further comprises:
receiving, by said computing system, a fourth list comprising a third set of required skills related to said job held by said job candidate;
receiving, by said computing system, professional/personal data;
storing within said computer usable medium, said fourth list and said professional/personal data;
comparing by said transition analysis tool, said first set of required skills with said third set of required skills to determine a second group of common skills between said first set of required skills and said third set of required skills;
calculating, by said transition analysis tool, a fourth score for said candidate by dividing the number of said second group of common skills by the number of said first set of required skills;
comparing by said career analysis tool, said professional/personal data with said first set of required skills to determine a first set of professional/personal valued skills from said first set of required skills; and
calculating by said transition analysis tool, a fifth score for said job candidate by dividing the number of said first set of professional/personal valued skills by the number of said first set of required skills.

23. The computer program product of claim 22, wherein said method further comprises:
receiving, by said computing system, time related data comprising formal education time estimates and practical application time estimates for learning said first specified job title; and
applying said time related data to said first score, said second score, said third score, said fourth score, and said fifth score.

24. The computer program product of claim 22, wherein said method further comprises:
calculating by said transition analysis tool, a first analysis score for said job candidate in relation to said first specified job title, wherein said first analysis score is based on a function of said first score, said second score, said third score, said fourth score, and said fifth score;
comparing said first analysis score to a first predetermined value; and
performing an action for said job candidate based on said comparing.

25. The computer program product of claim 24, wherein said method further comprises:
determining that said comparing said first analysis score to a first predetermined value results in said first analysis score exceeding said first predetermined value, wherein said performing said action comprises recommending said first specified job title to said job candidate.

26. The computer program product of claim 24, wherein said method further comprises:
determining that said comparing said first analysis score to a first predetermined value results in said first analysis score being less than said first predetermined value, wherein said performing said action comprises rejecting said first specified job title for said job candidate.

27. The computer program product of claim 22, wherein said method further comprises:
comparing by said transition analysis tool, said first score to a first predetermined value;
determining that said comparing said first score to said first predetermined value results in said first score exceeding said first predetermined value;
comparing by said transition analysis tool, said second score to a second predetermined value;
determining that said comparing said second score to said second predetermined value results in said second score exceeding said second predetermined value;
comparing by said transition analysis tool, said third score to a third predetermined value;
determining that said comparing said third score to said third predetermined value results in said third score exceeding said third predetermined value;
comparing by said transition analysis tool, said fourth score to a fourth predetermined value;
determining that said comparing said fourth score to said fourth predetermined value results in said fourth score exceeding said fourth predetermined value;
comparing by said transition analysis tool, said fifth score to a fifth predetermined value;
determining that said comparing said fifth score to said fifth predetermined value results in said fifth score exceeding said fifth predetermined value;
calculating by said transition analysis tool, a first analysis score for said job candidate in relation to said first specified job title, wherein said first analysis score is based on a function of said first score, said second score, said third score, said fourth score, and said fifth score;
comparing said first analysis score to a sixth predetermined value; and
performing an action for said job candidate based on said comparing said first analysis score to said sixth predetermined value.

28. The computer program product of claim 27, wherein said method further comprises:
determining that said comparing said first analysis score to said sixth predetermined value results in said first analysis score exceeding said sixth predetermined value, wherein said performing said action comprises recommending said first specified job title to said job candidate

29. The computer program product of claim 27, wherein said method further comprises:
determining that said comparing said first analysis score to said sixth predetermined value results in said first analysis score being less than said sixth predetermined value, wherein said performing said action comprises rejecting said first specified job title for said job candidate.

30. The computer program product of claim 21, wherein said method further comprises:
removing by said transition analysis tool, said first group and said second group of common skills from said first plurality of required skills to determine a first set of missing skills; and
recommending by said transition analysis tool, a training program for said job candidate to acquire said first set of missing skills.

31. A process for integrating computing infrastructure, comprising integrating computer-readable code into a computer system, wherein the computer system comprises a computer usable medium, wherein said computer usable medium comprises job related data, wherein said job related data comprises a first specified job title and a first list comprising a first plurality of required skills for said first specified job title, and wherein the code in combination with the computer system is capable of performing a method comprising:
receiving by said computing system, job candidate data, said job candidate data comprising a job candidate and a second list comprising a first set of required skills related to a job held by said job candidate;
receiving, by said computing system, job market data;
storing within said computer usable medium, said job candidate data and said job market data;
comparing, said first plurality of required skills with said first set of required skills to determine a first group of common skills between said first plurality of required skills and said first set of required skills;
calculating, a first score for said candidate by dividing the number of said first group of common skills by the number of said first plurality of required skills;
comparing, said job market data with said first plurality of required skills to determine a first set of market valued skills from said first plurality of required skills;
calculating, a second score for said job candidate by dividing the number of said first set of market valued skills by the number of said first plurality of required skills;
receiving, by said computing system, a third list comprising a second set of required skills related to said job held by said job candidate;
receiving, by said computing apparatus, business data;
storing within said computer usable medium, said third list and said business data;
comparing, said first set of required skills with said second set of required skills to determine a second group of common skills between said first set of required skills and said second set of required skills;
calculating, a third score for said candidate by dividing the number of said second group of common skills by the number of said first set of required skills;
comparing, said business data with said first plurality of required skills to determine a first set of business valued skills from said first plurality of required skills; and
calculating, a fourth score for said job candidate by dividing the number of said first set of business valued skills by the number of said first plurality of required skills.

32. The process of claim 31, wherein said method further comprises:
receiving, by said computing system, a fourth list comprising a third set of required skills related to said job held by said job candidate;
receiving, by said computing system, professional/personal data;
storing within said computer usable medium, said fourth list and said professional/personal data;
comparing, said first set of required skills with said third set of required skills to determine a second group of common skills between said first set of required skills and said third set of required skills;
calculating, a fourth score for said candidate by dividing the number of said second group of common skills by the number of said first set of required skills;
comparing, said professional/personal data with said first set of required skills to determine a first set of professional/personal valued skills from said first set of required skills; and
calculating, a fifth score for said job candidate by dividing the number of said first set of professional/personal valued skills by the number of said first set of required skills.

33. The process of claim 32, wherein said method further comprises:
receiving, by said computing system, time related data comprising formal education time estimates and practical application time estimates for learning said first specified job title; and
applying said time related data to said first score, said second score, said third score, said fourth score, and said fifth score.

34. The process of claim 32, wherein said method further comprises:
calculating, a first analysis score for said job candidate in relation to said first specified job title, wherein said first analysis score is based on a function of said first score, said second score, said third score, said fourth score, and said fifth score;
comparing said first analysis score to a first predetermined value; and
performing an action for said job candidate based on said comparing.

35. The process of claim 34, wherein said method further comprises:
determining that said comparing said first analysis score to a first predetermined value results in said first analysis score exceeding said first predetermined value, wherein said performing said action comprises recommending said first specified job title to said job candidate.

36. The process of claim 34, wherein said method further comprises:
determining that said comparing said first analysis score to a first predetermined value results in said first analysis score being less than said first predetermined value, wherein said performing said action comprises rejecting said first specified job title for said job candidate.

37. The process of claim 32, wherein said method further comprises:
comparing, said first score to a first predetermined value;
determining that said comparing said first score to said first predetermined value results in said first score exceeding said first predetermined value;
comparing, said second score to a second predetermined value;
determining that said comparing said second score to said second predetermined value results in said second score exceeding said second predetermined value;
comparing by said transition analysis tool, said third score to a third predetermined value;
determining that said comparing said third score to said third predetermined value results in said third score exceeding said third predetermined value;
comparing, said fourth score to a fourth predetermined value;
determining that said comparing said fourth score to said fourth predetermined value results in said fourth score exceeding said fourth predetermined value;
comparing, said fifth score to a fifth predetermined value;
determining that said comparing said fifth score to said fifth predetermined value results in said fifth score exceeding said fifth predetermined value;
calculating, a first analysis score for said job candidate in relation to said first specified job title, wherein said first analysis score is based on a function of said first score, said second score, said third score, said fourth score, and said fifth score;
comparing said first analysis score to a sixth predetermined value; and
performing an action for said job candidate based on said comparing said first analysis score to said sixth predetermined value.

38. The process of claim 37, wherein said method further comprises:
determining that said comparing said first analysis score to said sixth predetermined value results in said first analysis score exceeding said sixth predetermined value, wherein said performing said action comprises recommending said first specified job title to said job candidate

39. The process of claim 37, wherein said method further comprises:
determining that said comparing said first analysis score to said sixth predetermined value results in said first analysis score being less than said sixth predetermined value, wherein said performing said action comprises rejecting said first specified job title for said job candidate.

40. The process of claim 31, wherein said method further comprises:
removing by, said first group and said second group of common skills from said first plurality of required skills to determine a first set of missing skills; and
recommending, a training program for said job candidate to acquire said first set of missing skills.
